(19) United States
(12) Patent Application Publication
(10) Pub. No.: US 2016/0190716 A1
(43) Pub. Date: Jun. 30, 2016

(54) SOCKET THAT ENGAGES A PLURALITY OF ELECTRONIC PACKAGES

(71) Applicants: Kuang Liu, Queen Creek, AZ (US); Gregorio Murtagian, Phoenix, AZ (US); David J. Llapitan, Tacoma, WA (US); Jeffory L. Smalley, East Olympia, WA (US); Gaurav Chawla, Tempe, AZ (US); Joshua D. Heppner, Chandler, AZ (US); Vijaykumar Krithivasan, Chandler, AZ (US); Jonathan W. Thibado, Beaverton, OR (US)

(72) Inventors: Kuang Liu, Queen Creek, AZ (US); Gregorio Murtagian, Phoenix, AZ (US); David J. Llapitan, Tacoma, WA (US); Jeffory L. Smalley, East Olympia, WA (US); Gaurav Chawla, Tempe, AZ (US); Joshua D. Heppner, Chandler, AZ (US); Vijaykumar Krithivasan, Chandler, AZ (US); Jonathan W. Thibado, Beaverton, OR (US)

(21) Appl. No.: 14/583,357

(22) Filed: Dec. 26, 2014

(51) Int. Cl. H01R 12/70; H01R 43/20

(52) U.S. Cl. CPC H01R 12/7076; H01R 12/7047; H01R 43/205

(57) ABSTRACT

Some forms relate to a socket having a housing. A first receiving pin field is formed as part of the housing. The first pin receiving field includes a first plurality of electrical contacts. A second receiving pin field is formed as part of the housing. The second pin field includes a second plurality of electrical contacts. An actuation mechanism is configured to engage the first plurality electrical contacts with a first set of pins on a first electronic package and the second plurality electrical contacts with a second set of pins on a second electronic package.

### TECHNICAL FIELD

Some example embodiments of the present invention relate to a socket that engages a plurality of electronic packages, and more particularly to a socket that engages pin grid arrays on the plurality of electronic packages.

### BACKGROUND

The processors in integrated circuits and other electronic assemblies are continually being required to handle an ever-increasing number of signals. A typical processor often requires additional signals in order to operate at higher frequencies and to simultaneously perform more logic and memory operations.

Electrical sockets are often used to connect and secure electronic packages that include processors onto a system board (e.g., a mother board, interposer or a printed circuit board (PCB)). Most sockets are typically constructed for easy installation and replacement of the electronic packages. Many sockets include contacts that are assembled within the socket to provide an electrical connection between the system board and the electronic package that includes the processor.

Configurable memory for on package memory applications typically includes electronic packages that are connected under stringent space requirements. The volumetrics are very constrained due to limited form factor space on the substrates where the sockets are usually mounted.

Many of the conventional sockets (e.g., a Low Insertion Force Connector) typically require too much force to insert, or enable, an electronic package and often exceed ergonomic requirements. A specialized tool is also usually needed in order to install the electronic package memory on to a socket. In addition, when multiple sockets are mounted to a substrate an undesirably large keep out zone is typically required on the substrate.

### BRIEF DESCRIPTION OF THE DRAWINGS

FIG. 1 is a perspective view illustrating an example socket.

FIG. 2 is top view of the socket shown in FIG. 1.

FIG. 3 is top view of the socket shown in FIG. 2 where a cover of the socket has been moved relative to a base of the socket.

FIG. 4 is a side view of the socket shown in FIG. 1.

FIG. 5 is an end view of the socket shown in FIG. 1.

FIG. 6 is a partially exploded perspective view illustrating an example electronic assembly that includes the example socket shown in FIG. 1.

FIG. 7 is a top view of the electronic assembly shown in FIG. 6.

FIG. 8 is a side view of the electronic assembly shown in FIG. 6 where the electronic assembly includes one electronic package.

FIG. 9 is an exploded perspective view of the example socket shown in FIG. 6 with the pin grid arrays removed from the socket and the electronic packages removed from the pin grid arrays.

FIG. 10 is a partially exploded perspective view illustrating an example electronic system that includes several of the electronic assemblies shown in FIGS. 6-9 mounted onto a substrate.

FIG. 11 is a flow diagram illustrating an example method of forming an electronic assembly.

FIG. 12 is a block diagram of an electronic apparatus that includes the electronic assemblies and/or the sockets described herein.

### DETAILED DESCRIPTION

The following detailed description references the accompanying drawings. Like numerals describe substantially similar components throughout each of the drawings. Other embodiments may be used, and structural, logical, and electrical changes made. The sockets and electronic assemblies described herein can be manufactured, used, or shipped in a number of positions and orientations.

The example sockets described herein may allow for two or more packages per socket and reduce the insertion force to none. In addition, the example sockets described herein may not require specialized tools to mount an electronic package to the socket.

By using only one socket for two packages, the contribution of socket height to tolerance buildup may be reduced resulting in improved heat sink contact. The configuration of some of the sockets described herein may allow for electronic package memory to be installed over existing features on the substrate (e.g., a socket load frame). Installing electronic package memory over existing features on the substrate may further optimize the use of space.

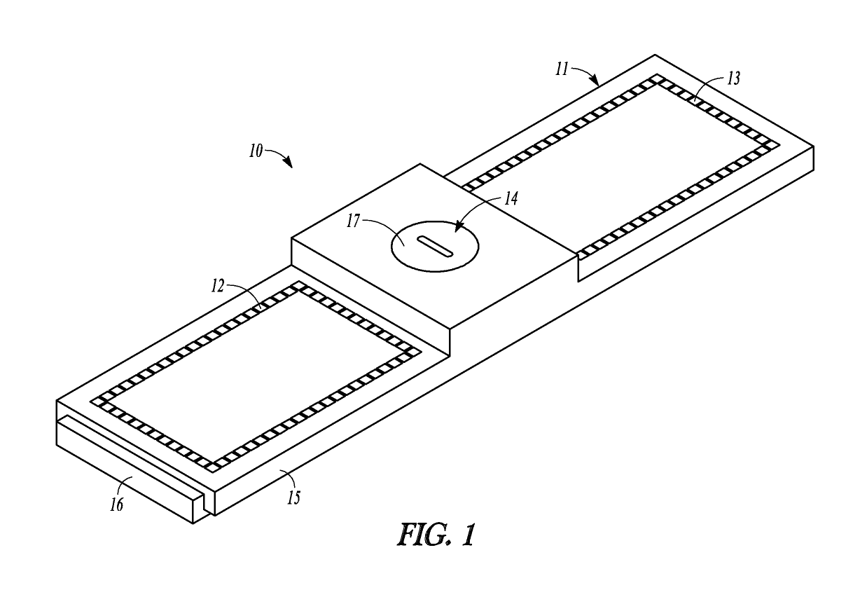

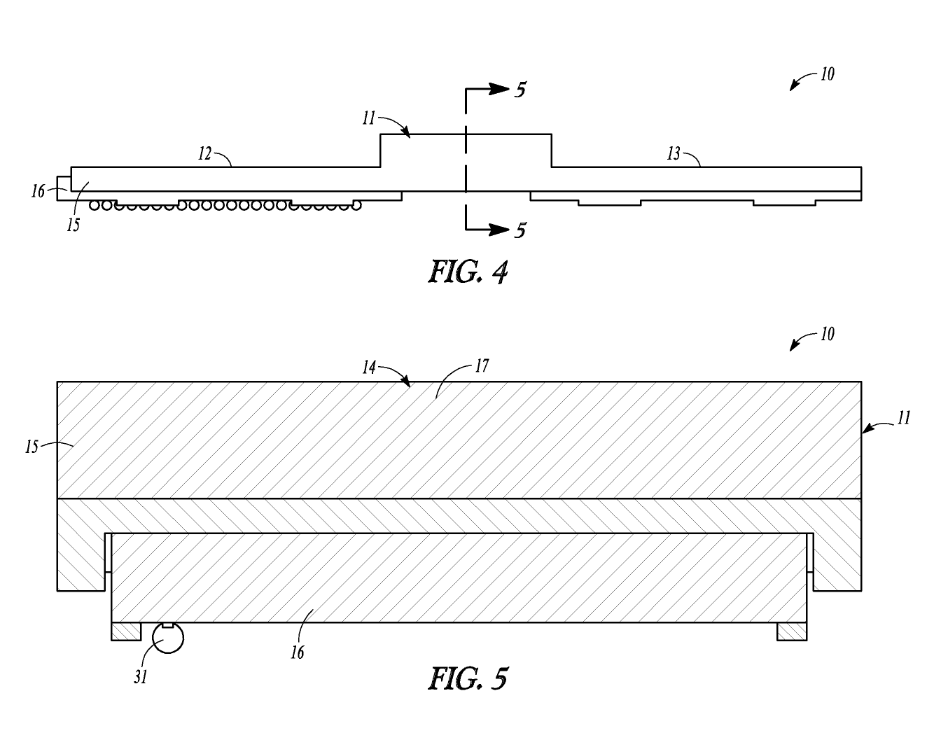

FIGS. 1-5 illustrate an example socket 10. The socket 10 includes a housing 11. The housing 11 includes a first receiving pin field 12 formed as part of the housing 11 and a second receiving pin field 13 formed as part of the housing 11. The first pin receiving field 12 includes a first plurality electrical contacts (not visible in housing 11) and the second pin field 13 includes a second plurality electrical contacts (not visible in housing 11).

The socket 10 further includes an actuation mechanism 14. The actuation mechanism 14 is configured to engage the first plurality electrical contacts with a first set of pins on a first electronic package and the second plurality electrical contacts with a second set of pins on a second electronic package. The first and second electronic packages are not shown in FIGS. 1-5, but are shown later relative to the electronic assemblies and methods described herein.

It should be noted that the actuation mechanism 14 may be any type of actuation mechanism that is known now or discovered in the future. The type of actuation mechanism 14 that is included in the socket 10 will depend in part on the size of the housing and the types of electronic packages that are to be connected to the socket 10 (among other factors).

In the example actuation mechanism 14 illustrated in FIGS. 1-3 and 5, the actuation mechanism 14 is a cam mechanism positioned between the first pin receiving field 12 and the second pin receiving field 13. In alternative forms, the actuation mechanism 14 may be positioned in other locations relative to the first pin receiving field 12 and the second pin receiving field 13.

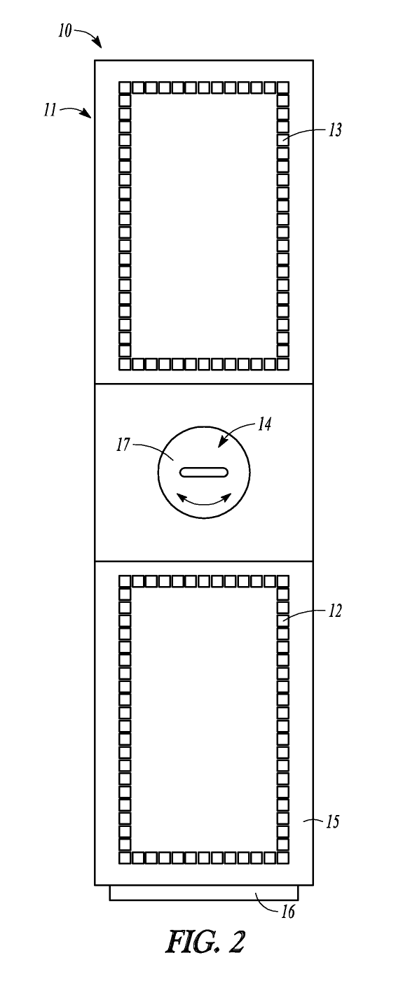

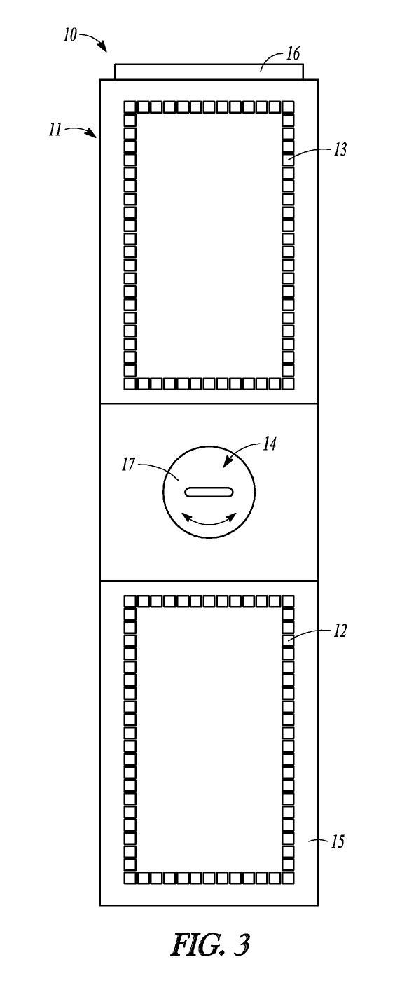

As shown in FIGS. 1-5, the housing 11 includes a cover plate 15 and a base 16. The cover plate 15 moves relative to the base 16 during operation of the actuation mechanism 14. Although the cover plate 15 is illustrated as moving linearly relative to the base 16 (compare FIGS. 2 and 3), other forms are contemplated where the cover plate 15 moves non-linearly relative to the base 16 (e.g., rotationally).

In the example socket 10 described herein, the base 16 includes the first plurality electrical contacts and the second plurality electrical contacts. The number and type of contacts in the first plurality electrical contacts and the second plurality electrical contacts will depend in part (i) the size of type of electronic packages that are to be connected to the socket 10; and (ii) the size, number and type of pins that are used to electrically connect electronic packages to the socket 10.

As shown in FIGS. 2 and 3, a portion 17 of the actuation mechanism 14 is rotated to move the cover plate 15 relative to the base 16. It should be noted that other types of devices are contemplated to move the cover plate 15 relative to the base 16 (e.g., a lever).

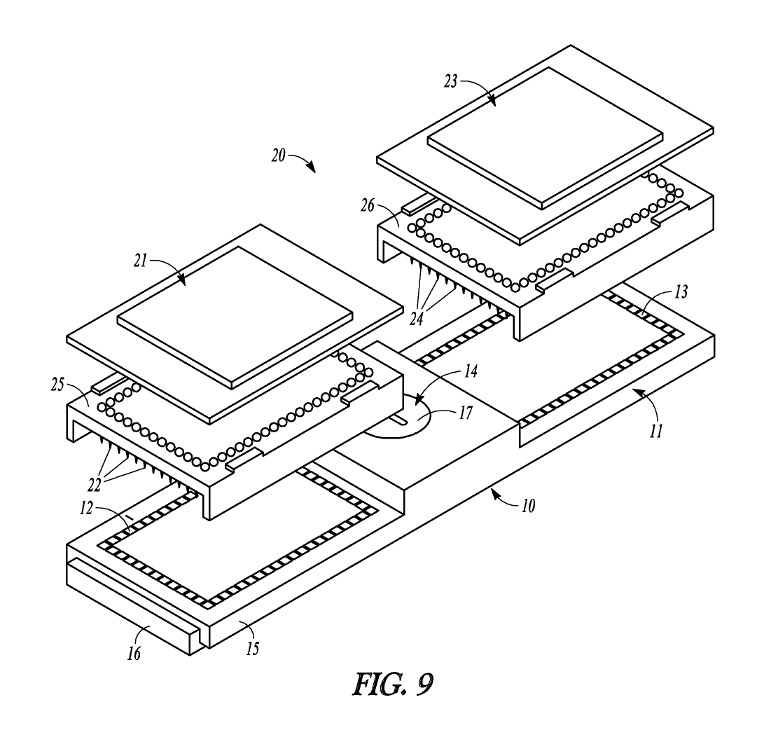

FIGS. 6-9 illustrate an example electronic assembly 20. The electronic assembly includes any of the example sockets 10 described herein. The electronic assembly 20 further includes a first electronic package 21 that includes a first pin grid array 22 and a second electronic package 23 that includes a second pin grid array 24 (see FIG. 9).

It should be noted that the number, location and size of the pins in each pin grid array 22, 24 will depend in part on the type of first and second electronic packages 21, 23 that are included in the electronic assembly 20 as well as the type of applications where the electronic assembly 20 will be used. In addition, the first electronic package 21 may be the same size as the second electronic package 23 or the first electronic package 21 may be a different size than the second electronic package 23.

The actuation mechanism 14 is configured to engage the first plurality electrical contacts in the socket 10 with the first pin grid array 22 on the first electronic package 21. The actuation mechanism 14 is also configured to engage the second plurality electrical contacts in the socket 10 with the second pin grid array 24 on the second electronic package 22. In some example forms of the electronic assembly 20, the actuation mechanism 14 simultaneously engages the first plurality electrical contacts with the first pin grid array 22 and the second plurality electrical contacts with the second pin grid array 24.

The electronic assembly 20 may further include a first pin carrier 25 attached to the first electronic package 21. The first pin carrier 25 includes the first pin grid array 23. The electronic assembly 20 may further include a second pin carrier 26 attached to the second electronic package 22. The second pin carrier 26 includes the second pin grid array 24. The size, type and configuration of the first and second pin carriers 25, 26 will depend in part on (i) the size and type of the first and second electronic packages 21, 23; (ii) the size and type of the first and second pin grid arrays 22, 24; and/or (iii) the size and type of socket 10 that is used in the electronic assembly 20 (among other factors).

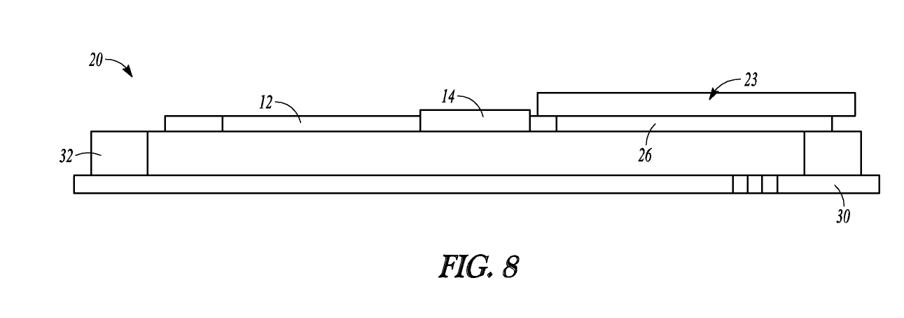

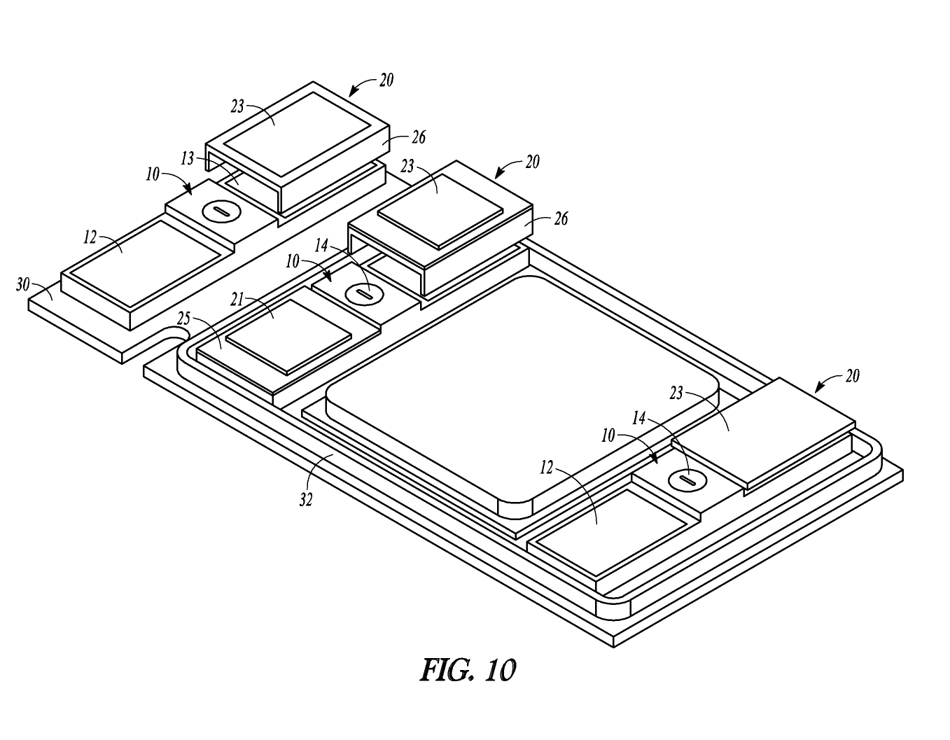

The electronic assembly 20 uses a single actuation mechanism 14 to secure first and second electronic package 23, 24. If two separate actuation mechanisms were used, then valuable XY space would be wasted on a substrate 30 (see FIGS. 8 and 10) where the electronic assembly(ies) 20 are mounted.

The need to operate only a single actuation mechanism 14 may also require less assembly time to fabricate the electronic assembly 20. It should be noted that forms of the electronic assembly 20 are contemplated where a single actuation mechanism 14 is used to secure more than two electronic packages.

In addition, either one, both, or none of the first and second electronic packages 21, 22 may be installed in the socket 10 any given time (see FIGS. 8 and 10). As an example, the socket 10 may be designed such that turning the portion 17 of the mechanism 14 would either (i) push both electronic packages 21, 23; or (ii) push one electronic package and pull the other electronic package to engage the first and second pin grid arrays 22, 24 with the first and second electronic packages 21, 23.

In the example electronic assembly 20 illustrated in FIGS., the actuation mechanism 14 is a cam mechanism positioned between the first electronic package 21 and the second electronic package 23. In alternative forms, the actuation mechanism 14 may be positioned in other locations relative to the first electronic package 21 and the second electronic package 23.

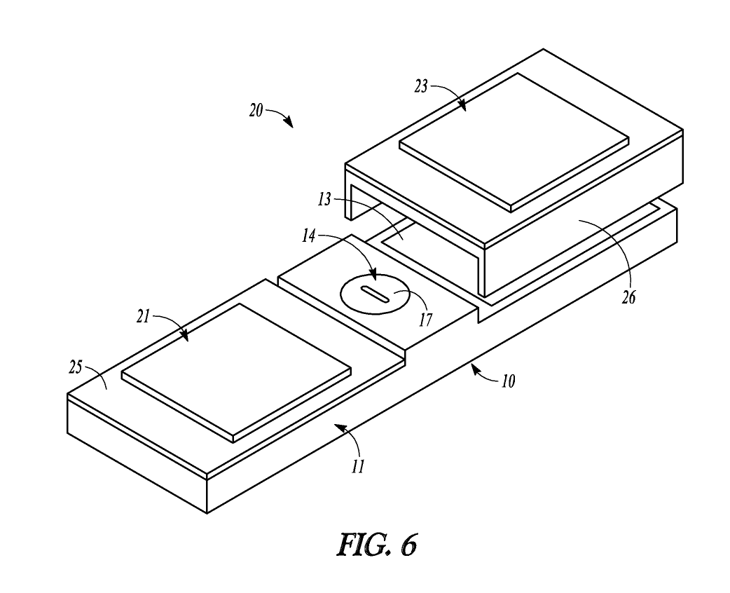

As shown in FIGS. 8 and 10, the housing 11 of the socket 10 may be mounted to a substrate 30. In some forms, the substrate 30 may be a printed circuit board such that the socket 10 is mounted to the printed circuit board. As an example, the socket 10 may be mounted to the printed circuit board using a ball grid array 31 (see FIG. 5).

As shown in FIGS. 8 and 10, the electronic assembly 20 may further include a socket load frame 32 mounted to the substrate 30. The socket load frame 32 may surround all, or part, of the housing 11 on the socket 10. In the example form that is illustrated in FIG. 8, at least one of the first electronic package 21 and the second electronic package 23 may extend over (i.e., overlap) the socket load frame 32 (second electronic package 23 overlaps in FIG. 8).

The size of the electronic assembly 20 may allow for easier 3 dimensional stacking of the various components that form the electronic assembly 20. As an example, a larger electronic package (e.g., a memory module) may be used in the electronic assembly 20 since the larger electronic package may overlap the socket load frame 32. In some forms, this extra space may be used for passive components, routing, interposer, etc. FIG. 8 shows most clearly the overlapping of an electronic package with the socket load frame 32.

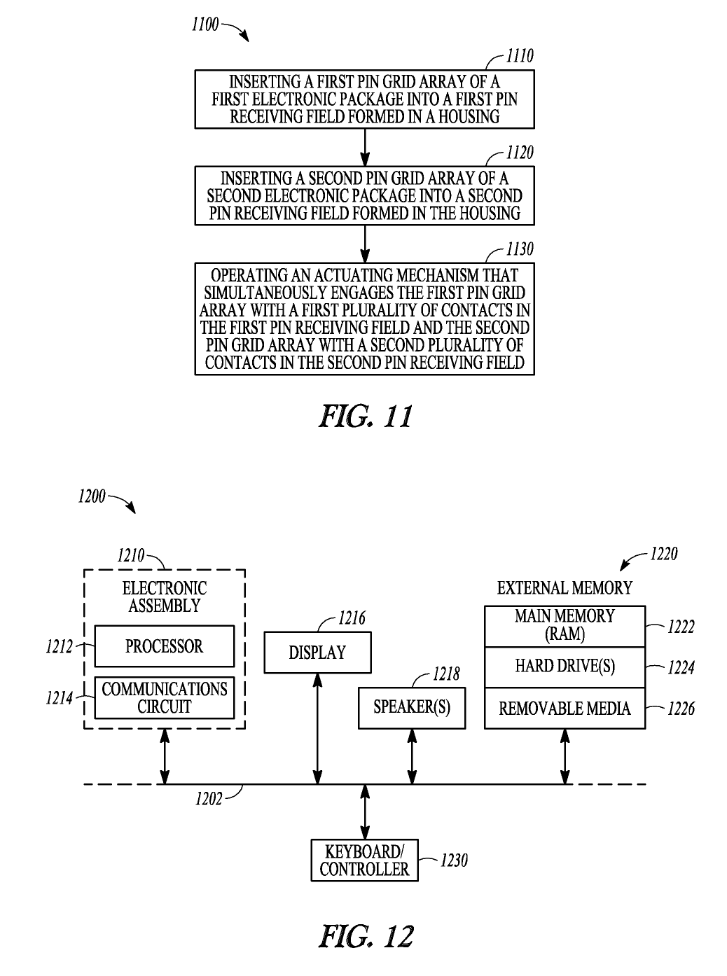

FIG. 11 shows a method [1100] of forming an electronic assembly 20. The method [1100] includes [1110] inserting a first pin grid array 22 of a first electronic package 21 into a first pin receiving field 12 formed in a housing 11 and inserting a second pin grid array 24 of a second electronic package 22 into a second pin receiving field 13 formed in the housing 11 (see, e.g., FIGS. 6 and 9). The first and second pin grid arrays 22, 24 may be inserted into the respective first and second receiving fields 12, 13.

The method [1100] further includes [1130] operating an actuating mechanism 14 that engages the first pin grid array 22 with a first plurality of contacts in the first pin receiving field 12 and the second pin grid array 24 with a second plurality of contacts in the second pin receiving field 13. The manner in which the first plurality of contacts engages the first pin grid array 22 and the second plurality of contacts engages the second pin grid array 24 will depend in part on the size, type and arrangement of the respective pins and contacts (among other factors).

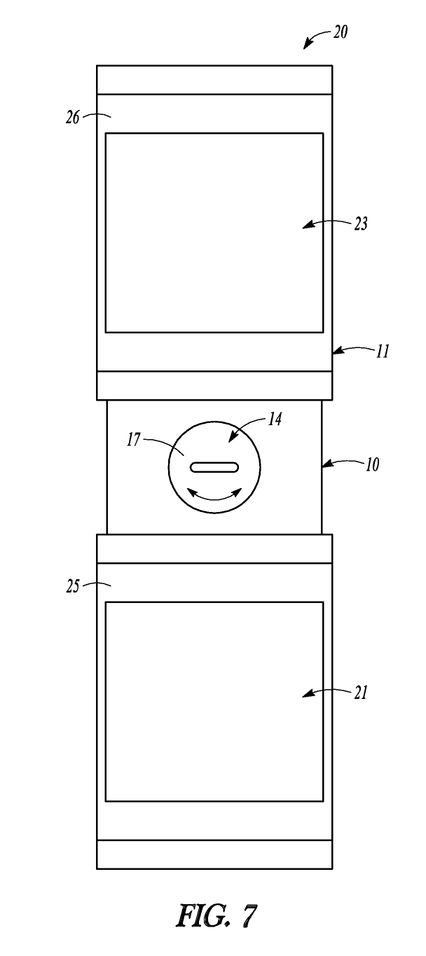

As shown in FIG. 7, [1130] operating the actuating mechanism 14 may include rotating a portion 17 of the actuation mechanism 14. It should be noted that other types of devices are contemplated to move the cover plate 15 relative to the base 16. In addition, the portion 17 may be moved in other ways besides rotating (e.g., linear motion using a lever).

In some forms, [1110] inserting the first pin grid array 22 into the first pin receiving field 12 may include inserting a first pin carrier 25 that includes the first pin grid array 22 into the first pin receiving field 12 where the first electronic package 21 is attached to the first pin carrier 25. In addition, [1120] inserting the second pin grid array 24 into the second pin receiving field 13 may include inserting a second pin carrier 26 that includes the second pin grid array 24 into the second pin receiving field 13 where the second electronic package 23 is attached to the second pin carrier 26.

In some forms, [1110] inserting the first pin grid array 22 of the first electronic package 21 into the first pin receiving field 12 may include positioning a portion of the first electronic package 21 over a socket load frame 32 that surrounds the housing 11. In addition, [1120] inserting the second pin grid array 24 into the second pin receiving field 13 may include positioning a portion of the second electronic package 23 over the socket load frame 32 that surrounds the housing 11 (see, e.g., FIGS. 8 and 10).

The sockets, electronic assemblies and methods described herein may require zero insertion force, no custom tool requirement for assembly, and socket robustness. In addition, the sockets, electronic assemblies and methods described herein may allow electronic packages to be installed at any convenient time in the manufacturing process and/or system assembly, or as part of performing service or maintenance.

The sockets and electronic assemblies described herein may be implemented in a number of different forms. The elements, materials, geometries, and dimensions can all be varied to suit particular packaging requirements.

FIG. 12 is a block diagram of an electronic apparatus 1200 incorporating at least one socket 10, electronic assembly 20 and/or method [1100] described herein. Electronic apparatus 1200 is merely one example of an electronic apparatus in which forms of the sockets 10, methods [1100] and electronic assemblies 20 described herein may be used.

Examples of an electronic apparatus 1200 include, but are not limited to, personal computers, tablet computers, mobile telephones, game devices, MP3 or other digital music players, etc. In this example, electronic apparatus 1200 comprises a data processing system that includes a system bus 1202 to couple the various components of the electronic apparatus 1200. System bus 1202 provides communications links among the various components of the electronic apparatus 1200 and may be implemented as a single bus, as a combination of busses, or in any other suitable manner.

An electronic assembly 1210 that includes at least one socket 10, electronic assembly 20 and/or method [1100] described herein may be coupled to system bus 1202. The electronic assembly 1210 may include any circuit or combination of circuits. In one embodiment, the electronic assembly 1210 includes a processor 1212 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 1210 are a custom circuit, an application-specific integrated circuit (ASIC), or the like, such as, for example, one or more circuits (such as a communications circuit 1214) for use in wireless devices like mobile telephones, tablet computers, laptop computers, two-way radios, and similar electronic systems. The IC can perform any other type of function.

The electronic apparatus 1200 may also include an external memory 1220, which in turn may include one or more memory elements suitable to the particular application, such as a main memory 1222 in the form of random access memory (RAM), one or more hard drives 1224, and/or one or more drives that handle removable media 1226 such as compact disks (CD), flash memory cards, digital video disk (DVD), and the like.

The electronic apparatus 1200 may also include a display device 1216, one or more speakers 1218, and a keyboard and/or controller 1230, which can include a mouse, trackball, touch screen, voice-recognition device, or any other device that permits a system user to input information into and receive information from the electronic apparatus 1200.

To better illustrate the methods, sockets and electronic assemblies disclosed herein, a non-limiting list of embodiments is provided herein,

Example 1 includes a socket having a housing. A first receiving pin field is formed as part of the housing. The first pin receiving field includes a first plurality electrical contacts. A second receiving pin field is formed as part of the housing. The second pin field includes a second plurality electrical contacts. An actuation mechanism is configured to engage the first plurality electrical contacts with a first set of pins on a first electronic package and the second plurality electrical contacts with a second set of pins on a second electronic package.

Example 2 includes the socket of example 1, wherein the actuation mechanism is a cam mechanism.

Example 3 includes the socket of any one of examples 1-2, wherein the actuation mechanism is between the first pin receiving field and the second pin receiving field.

Example 4 includes the socket of any one of examples 1-3, wherein the housing includes a cover plate and a base, wherein the cover plate moves relative to the base during operation of the actuation mechanism.

Example 5 includes the socket of any one of example 4, wherein the base includes the first plurality electrical contacts and the second plurality electrical contacts.

Example 6 includes the socket of any one of examples 4-5, wherein a portion of the actuation mechanism is rotated to move the cover plate relative to the base.

Example 7 includes an electronic assembly. The electronic assembly includes a socket that includes a housing with a first receiving pin field and a second receiving pin field. The first pin receiving field includes a first plurality electrical contacts and the second pin field includes a second plurality electrical contacts. A first electronic package includes a first pin grid array. A second electronic package includes a second pin grid array. An actuation mechanism engages the first plurality electrical contacts with the first pin grid array and the second plurality electrical contacts with the second pin grid array.

Example 8 includes the electronic assembly of example 7, wherein the actuation mechanism is between the first electronic package and the second electronic package.

Example 9 includes the electronic assembly of any one of examples 7-8, wherein the housing includes a cover plate and a base, wherein the cover plate moves relative to the base during operation of the actuation mechanism, wherein the base includes the first plurality of contacts and the second plurality of contacts.

Example 10 includes the electronic assembly of any one of examples 7-9, and further including a first pin carrier attached to the first electronic package. The first pin carrier includes the first pin grid array. A second pin carrier is attached to the second electronic package. The second pin carrier includes the second pin grid array.

Example 11 includes the electronic assembly of any one of examples 7-10, wherein the first electronic package is a same size as the second electronic package.

Example 12 includes the electronic assembly of any one of examples 7-11, wherein the housing is mounted to a substrate.

Example 13 includes the electronic assembly of example 12, and further including a socket load frame mounted to the substrate. The socket load frame surrounds the housing. At least one of the first electronic package and the second electronic package extends over the socket load frame.

Example 14 includes a method that includes inserting a first pin grid array of a first electronic package into a first pin receiving field formed in a housing and inserting a second pin grid array of a second electronic package into a second pin receiving field formed in the housing. The method further includes operating an actuating mechanism that simultaneously engages the first pin grid array with a first plurality of contacts in the first pin receiving field and the second pin grid array with a second plurality of contacts in the second pin receiving field.

Example 15 includes the method of example 14, wherein operating the actuating mechanism includes rotating a portion of the actuation mechanism.

Example 16 includes the method of any one of examples 14-15, wherein inserting the first pin grid array into the first pin receiving field includes inserting a first pin carrier that includes the first pin grid array into the first pin receiving field, wherein the first electronic package is attached to the first pin carrier.

Example 17 includes the method of any one of examples 14-16, wherein inserting the second pin grid array into the second pin receiving field includes inserting a second pin carrier that includes the second pin grid array into the second pin receiving field, wherein the second electronic package is attached to the second pin carrier.

Example 18 includes the method of any one of examples 14-17, wherein the housing is formed of a cover plate and a base that includes the first and second plurality of contacts such that operating the actuating mechanism includes moving the cover plate relative to the base.

Example 19 includes the method of any one of examples 14-18, wherein inserting the first pin grid array of the first electronic package into the first pin receiving field includes positioning a portion of the first electronic package over a socket load frame that surrounds the housing.

Example 20 includes the method of any one of examples 14-19, wherein inserting the second pin grid array of the second electronic package into the second pin receiving field includes positioning a portion of the second electronic package over the socket load frame that surrounds the housing.

This overview is intended to provide non-limiting examples of the present subject matter. It is not intended to provide an exclusive or exhaustive explanation. The detailed description is included to provide further information about the sockets, electronic assemblies and methods.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. In addition, the order of the methods described herein may be in any order that permits fabrication of an electrical interconnect and/or package that includes an electrical interconnect. Other embodiments can be used, such as by one of ordinary skill in the art upon reviewing the above description.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. A socket comprising:
a housing;
a first receiving pin field formed as part of the housing, the first pin receiving field including a first plurality of electrical contacts;
a second receiving pin field formed as part of the housing, the second pin field including a second plurality of electrical contacts; and
an actuation mechanism that is configured to engage the first plurality of electrical contacts with a first set of pins on a first electronic package and the second plurality of electrical contacts with a second set of pins on a second electronic package, and wherein the actuation mechanism is between the first pin receiving field and the second pin receiving field.

2. The socket of claim 1, wherein the actuation mechanism is a cam mechanism.

3. (canceled)

4. The socket of claim 1, wherein the housing includes a cover plate and a base, wherein the cover plate moves relative to the base during operation of the actuation mechanism.

5. The socket of claim 4, wherein the base includes the first plurality electrical contacts and the second plurality electrical contacts.

6. The socket of claim 4, wherein a portion of the actuation mechanism is rotated to move the cover plate relative to the base.

7. An electronic assembly comprising:
a socket that includes a housing with a first receiving pin field and a second receiving pin field, the first pin receiving field including a first plurality electrical contacts and the second pin field including a second plurality electrical contacts;
a first electronic package that includes a first pin grid array;
a second electronic package that includes a second pin grid array;
an actuation mechanism that engages the first plurality electrical contacts with the first pin grid array and the second plurality electrical contacts with the second pin grid array;
a substrate, wherein the housing is mounted to a substrate; and
a socket load frame mounted to the substrate, the socket load frame surrounding the housing, wherein at least one of the first electronic package and the second electronic package extends over the socket load frame.

8. The electronic assembly of claim 7, wherein the actuation mechanism is between the first electronic package and the second electronic package.

9. The electronic assembly of claim 7, wherein the housing includes a cover plate and a base, wherein the cover plate moves relative to the base during operation of the actuation mechanism, wherein the base includes the first plurality of contacts and the second plurality of contacts.

10. The electronic assembly of claim 7, further comprising:
a first pin carrier attached to the first electronic package, wherein the first pin carrier includes the first pin grid array; and
a second pin carrier attached to the second electronic package, wherein the second pin carrier includes the second pin grid array.

11. The electronic assembly of claim 7, wherein the first electronic package is a same size as the second electronic package.

12-13. (canceled)

14. A method comprising:
inserting a first pin grid array of a first electronic package into a first pin receiving field formed in a housing;
inserting a second pin grid array of a second electronic package into a second pin receiving field formed in the housing; and
operating an actuating mechanism that is positioned between the first pin grid array and the second pin grid array to simultaneously engage the first pin grid array with a first plurality of contacts in the first pin receiving field and the second pin grid array with a second plurality of contacts in the second pin receiving field.

15. The method of claim 14, wherein operating the actuating mechanism includes rotating a portion of the actuation mechanism.

16. The method of claim 15, wherein inserting the first pin grid array into the first pin receiving field includes inserting a first pin carrier that includes the first pin grid array into the first pin receiving field, wherein the first electronic package is attached to the first pin carrier.

17. The method of claim 16, wherein inserting the second pin grid array into the second pin receiving field includes inserting a second pin carrier that includes the second pin grid array into the second pin receiving field, wherein the second electronic package is attached to the second pin carrier.

18. The method of claim 14, wherein the housing is formed of a cover plate and a base that includes the first and second plurality of contacts such that operating the actuating mechanism includes moving the cover plate relative to the base.

19. A method comprising:
inserting a first pin grid array of a first electronic package into a first pin receiving field formed in a housing;
inserting a second pin grid array of a second electronic package into a second pin receiving field formed in the housing; and
operating an actuating mechanism that simultaneously engages the first pin grid array with a first plurality of contacts in the first pin receiving field and the second pin grid array with a second plurality of contacts in the second pin receiving field, wherein inserting the first pin grid array of the first electronic package into the first pin receiving field includes positioning a portion of the first electronic package over a socket load frame that surrounds the housing.

20. The method of claim 19, wherein inserting the second pin grid array of the second electronic package into the second pin receiving field includes positioning a portion of the second electronic package over a socket load frame that surrounds the housing.
